(19) United States
(12) Patent Application Publication
(10) Pub. No.: US 2020/0080001 A1
(43) Pub. Date: Mar. 12, 2020

(54) COMPOSITION, LIQUID CRYSTAL DISPLAY DEVICE, AND ELECTRONIC APPARATUS

(71) Applicant: SHARP KABUSHIKI KAISHA, Sakai City, Osaka (JP)

(72) Inventors: MASANOBU MIZUSAKI, Sakai City, Osaka (JP); TOMONORI ITOH, Sakai City, Osaka (JP)

(21) Appl. No.: 16/498,288

(22) PCT Filed: Mar. 28, 2018
(86) PCT No.: PCT/JP2018/012943

§ 371 Date: Sep. 26, 2019

(30) Foreign Application Priority Data
Mar. 31, 2017 (JP) 2017-069975

(51) Int. Cl. C09K 19/30; C09K 19/38; C09K 19/40

(52) U.S. Cl. CPC C09K 19/3003; C09K 19/3809; C09K 2019/301; C09K 2019/3004; C09K 19/406

(57) ABSTRACT

A composition contains a first polyamic acid and a second polyamic acid. The first polyamic acid has at least one of a photoreactive functional group and a vertical alignment group. The second polyamic acid has a repeat unit that has a pendant alkoxysilyl group.

### TECHNICAL FIELD

Aspects of the present invention relate to a composition, a liquid crystal display device, and an electronic apparatus.

This application claims priority to Japanese Patent Application No. 2017-069975, filed in Japan on Mar. 31, 2017, the contents of which are hereby incorporated by reference.

### BACKGROUND ART

Liquid crystal display devices have been used widely as displays of smartphones and other mobile electronic devices, television sets, personal computers, etc.

A liquid crystal display device has a liquid crystal layer made from a liquid crystal composition and alignment films between which the liquid crystal layer is sandwiched. With their anchoring strength, the alignment films give a predetermined pretilt angle to liquid crystal molecules contained in the liquid crystal composition. The performance of the alignment films has a great impact on that of the liquid crystal display device, such as the VHR (Voltage Holding Ratio) and contrast of the liquid crystal display device.

For this reason, a wide variety of materials have been studied and proposed as materials for alignment films (e.g., see PTL 1).

### CITATION LIST

### Patent Literature

PTL 1: Japanese Unexamined Patent Application Publication No. 2015-20999

### SUMMARY OF INVENTION

### Technical Problem

The recent increase in the resolution of liquid crystal display devices has created a need for delicately designed alignment films in which the direction of alignment varies in small areas. A known example of such an alignment film is a photoalignment film, a type of alignment film with varying anchoring strengths as a result of a photofunctional group the alignment film has being irradiated with light in different directions.

Known alignment films are not always formed single-layer but may have a multilayer structure. An alignment film needs to have different characteristics on its substrate side and liquid-crystal-layer side. Multilayer alignment films, which are stacks of layers with different characteristics selected to meet such characteristics requirements, offer the advantages of higher flexibility in design and easier production of high-performance films.

A multilayer alignment film can be produced by making each layer of it and then stacking the layers. Such a production method, however, involves an increased number of production steps and often causes an increase in production cost.

Worse yet, the increase in the number of steps leads to reduced production yield.

As a solution to this, a known technology uses a composition made by mixing materials for the individual layers of the alignment film. When the composition is coated onto a surface, the materials are allowed to separate into layers, thereby giving a multilayer alignment film. Known examples of such compositions include mixtures of a polyamic acid with a polysiloxane having a photofunctional group and mixtures of a polyamic acid having a photofunctional group with a polyamic acid having no photofunctional group.

Of these, alignment film materials (compositions) made from a mixture of a polyamic acid having a photofunctional group with a polyamic acid having no photofunctional group do not easily separate into layers. With many of such materials, the characteristics tend not to be as designed. This type of material therefore needs to be further improved.

Aspects of the present invention were made in view of these circumstances and are aimed at providing a novel composition with which high-performance liquid crystal display devices can be made. Another object is to provide a liquid crystal display device that includes this composition. It is also an object of aspects of the present invention to provide an electronic apparatus that includes this liquid crystal display device.

### Solution to Problem

To solve the above problem, a form of the present invention provides a composition. The composition contains a first polyamic acid and a second polyamic acid. The first polyamic acid has at least one of a photoreactive functional group and a vertical alignment group. The second polyamic acid has a repeat unit having a pendant alkoxysilyl group.

In a form of the present invention, the repeat unit having an alkoxysilyl group may be present in an amount of 0.05% by mass or more and 30% by mass or less of the whole composition.

In a form of the present invention, the repeat unit having an alkoxysilyl group may contain at least one group selected from the group consisting of formulae (E-201) to (E-206) below.

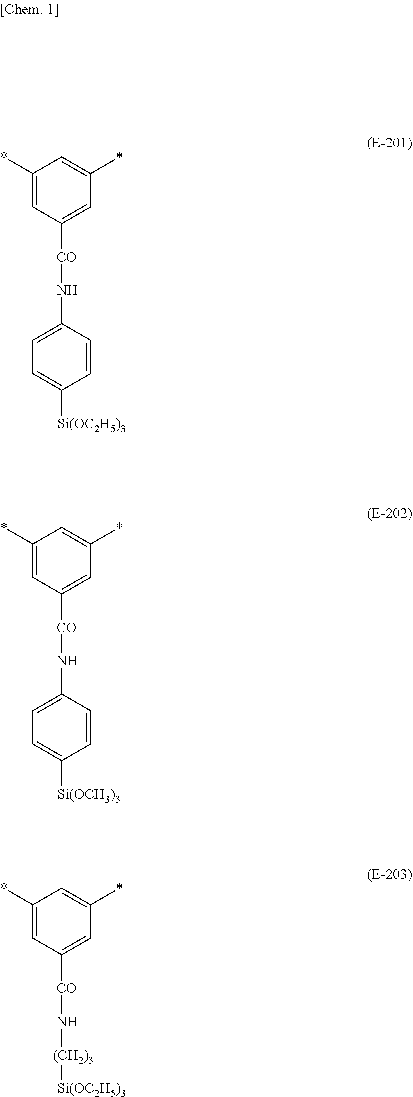

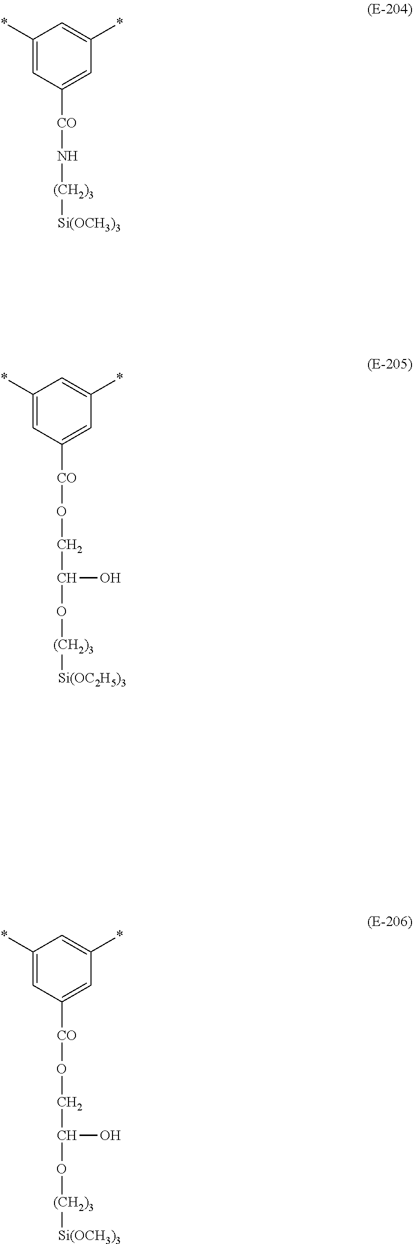

In a form of the present invention, the repeat unit having an alkoxysilyl group may be present in an amount of 2 mol % or more and 30 mol % or less of all repeat units forming the second polyamic acid.

In a form of the present invention, the photoreactive functional group may be a group having an azobenzene structure or a group having a cyclobutane ring.

In a form of the present invention, the photoreactive functional group may be contained in the backbone of the first polyamic acid.

A form of the present invention, moreover, provides a liquid crystal display device. The liquid crystal display device has a pair of substrates, a liquid crystal layer sandwiched between the pair of substrates, and alignment films on the surfaces of the pair of substrates closer to the liquid crystal layer. At least one of the alignment films the pair of substrates respectively have is a multilayer film including an upper alignment film, which is closer to the liquid crystal layer, and a lower alignment film, which lies between the upper alignment film and the substrate. The liquid crystal layer contains a positive liquid crystal material, the upper alignment film contains the aforementioned first polyamic acid, the lower alignment film contains the aforementioned second polyamic acid, and the multilayer film is made from the aforementioned composition.

In a form of the present invention, the liquid crystal composition in the liquid crystal layer may contain a liquid crystal compound having an alkenyl group.

In a form of the present invention, the liquid crystal composition may contain at least one compound selected from the group consisting of formulae (C1) to (C4) below.

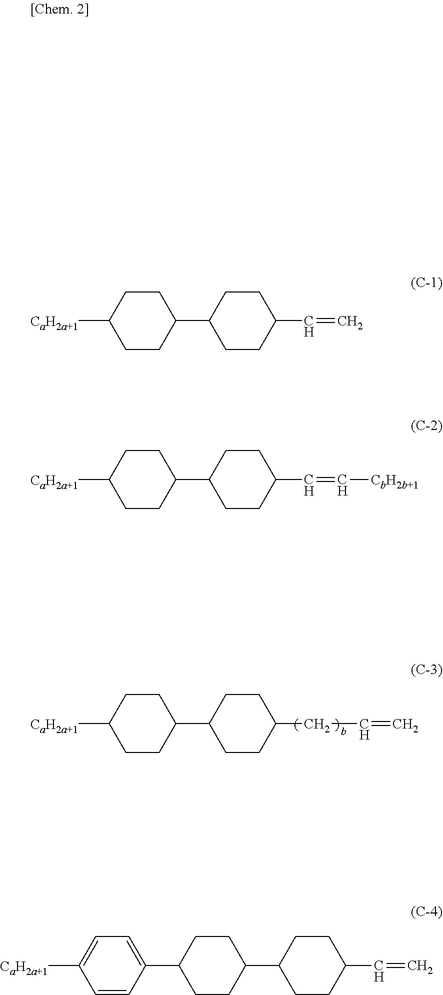

(In the formulae, a and b are mutually independent integers of 1 to 6.)

An aspect of the present invention, furthermore, provides an electronic apparatus that has a liquid crystal display device as described above.

### Advantageous Effects of Invention

According to aspects of the present invention, it is possible to provide a novel composition with which high-performance liquid crystal display devices can be made. It is also possible to provide a liquid crystal display device that includes this composition. An electronic apparatus that includes this liquid crystal display device can also be provided.

### BRIEF DESCRIPTION OF DRAWINGS

FIG. 1 is a cross-sectional diagram schematically illustrating a liquid crystal display device of Embodiment 2.

FIG. 2 is a schematic diagram illustrating an electronic apparatus of Embodiment 3.

FIG. 3 is a schematic diagram illustrating an electronic apparatus of Embodiment 3.

FIG. 4 is a schematic diagram illustrating an electronic apparatus of Embodiment 3.

FIG. 5 is a schematic diagram illustrating an electronic apparatus of Embodiment 3.

### DESCRIPTION OF EMBODIMENTS

### Embodiment 1

### <Composition>

A composition according to Embodiment 1 of the present invention contains a first polyamic acid and a second polyamic acid. The first polyamic acid has at least one of a photoreactive functional group and a vertical alignment group. The second polyamic acid has a repeat unit having a pendant alkoxysilyl group.

A composition of this embodiment is suitable for use as a material for alignment film(s) of a liquid crystal display device. That is, a composition of this embodiment forms a good alignment film when applied to a substrate, heated, and then optionally subjected to a predetermined process of light irradiation.

A first polyimide, which is obtained through intramolecular cyclization (imidization) of the first polyamic acid, is positioned closer to the liquid crystal layer in the liquid crystal display device and has anchoring strength to the liquid crystal composition forming the liquid crystal layer.

A second polyimide, which is obtained through intramolecular cyclization (imidization) of the second polyamic acid, is positioned closer to the substrate in the liquid crystal display device and firmly binds to the substrate as an underlayer.

The layer formed by the second polyimide, moreover, fuses and firmly binds with the layer formed by the first polyimide at the interface therebetween. By virtue of this, the layer formed by the first polyimide is firmly bound to the substrate by the layer formed by the second polyimide.

### (First Polyamic Acid)

The first polyimide, obtained through the imidization of the first polyamic acid, functions as a photoalignment or vertical alignment film in the liquid crystal display device.

### (Photoalignment Film)

If used to form a photoalignment film, the first polyamic acid can have a basic structure that has the polyamic acid structure represented by formula (10) below and in which the X unit in the polyamic acid is any of formulae (X-1) to (X-11) below and in which the E unit in the polyamic acid is any of formulae (E-1) to (E-11) below.

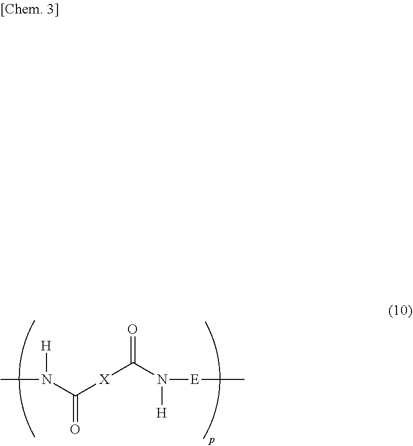

(In the formula, p represents an integer)

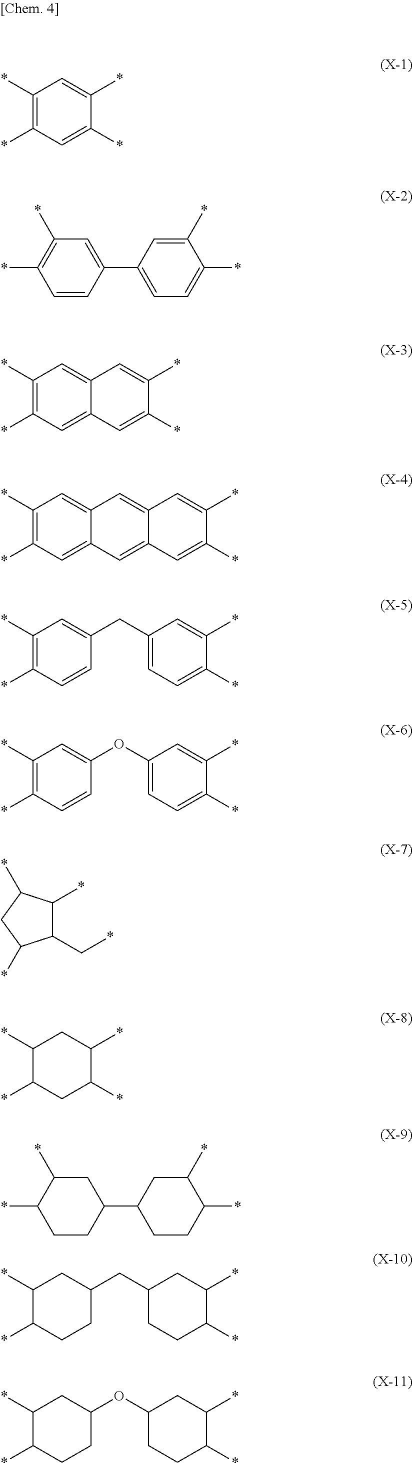

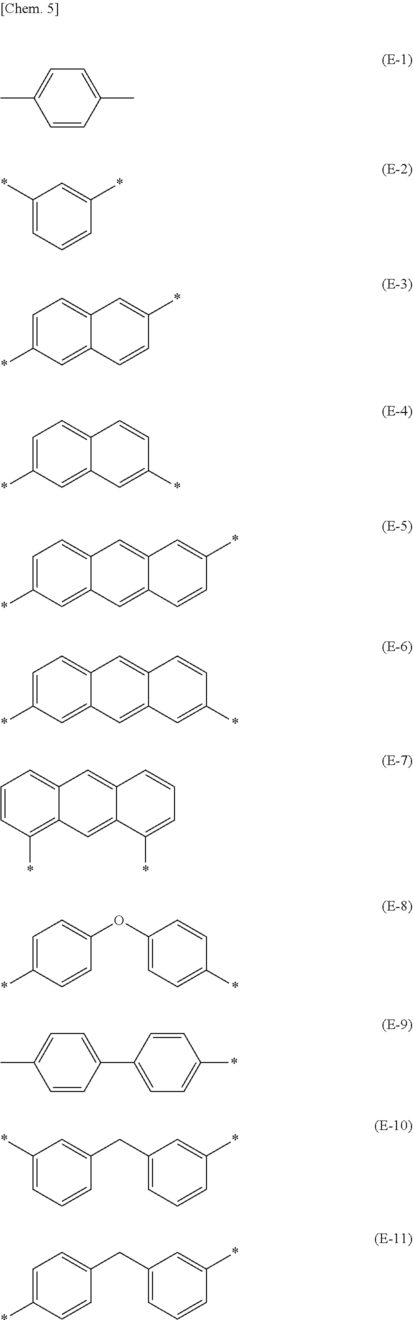

The first polyamic acid further has any photofunctional group(s) described below to replace at least one of the X and E units.

To be more specific, examples of photofunctional groups the X unit can use in the polyamic acid structure represented by formula (10) above include a group that has such an azobenzene group as represented by formula (X-101) below, and a group that has such a cyclobutane ring as represented by (X-102) below.

The group having an azobenzene group, such as represented by formula (X-101) below, or the group having a cyclobutane ring, such as represented by (X-102) below, is therefore contained in the backbone of the first polyamic acid.

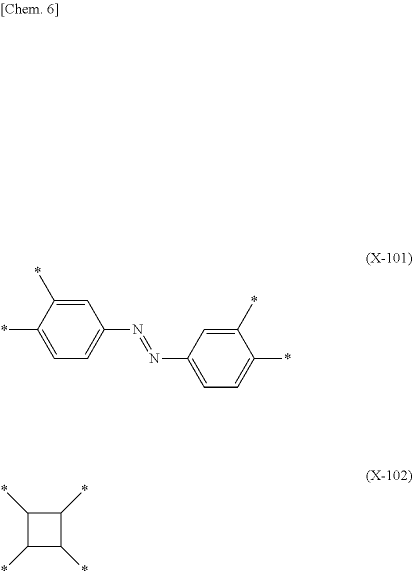 [SMILES: *c1ccc(/N=N/c2ccc(*)c(*)c2)cc1* ; *C1C(*)C(*)C1*]

Examples of photofunctional groups the E unit can use include formulae (E-101) to (E-106) below.

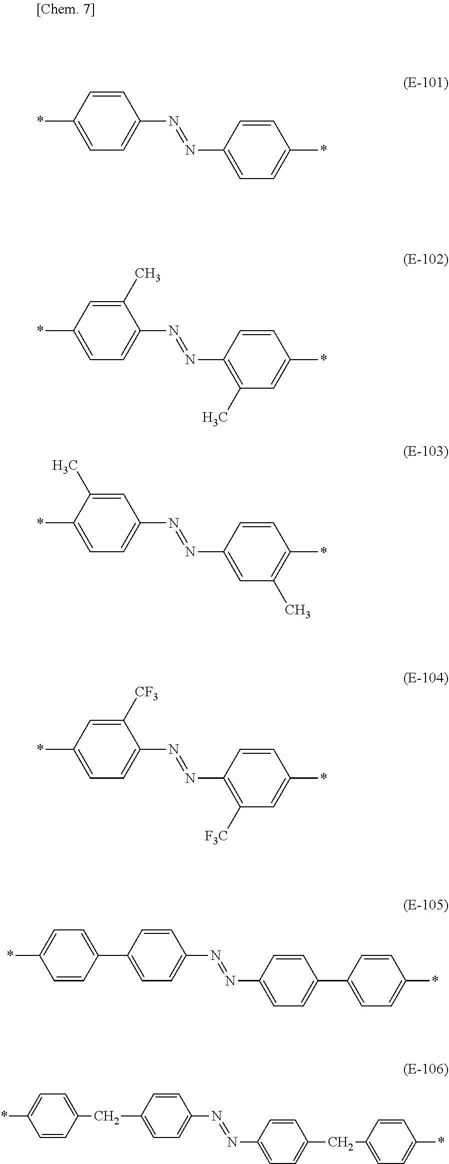 [SMILES: *c1ccc(/N=N/c2ccc(*)cc2)cc1 ; *c1ccc(/N=N/c2ccc(*)cc2C)c(C)c1 ; *c1ccc(/N=N/c2ccc(*)c(C)c2)cc1C ; *c1ccc(/N=N/c2ccc(*)cc2C(F)(F)F)c(C(F)(F)F)c1 ; *c1ccc(-c2ccc(/N=N/c3ccc(-c4ccc(*)cc4)cc3)cc2)cc1 ; *c1ccc(Cc2ccc(/N=N/c3ccc(Cc4ccc(*)cc4)cc3)cc2)cc1]

### (Vertical Alignment Film)

If used as a vertical alignment film, the first polyamic acid can be, for example, one that has the polyamic acid structure represented by formula (11) below and in which the X unit in the polyamic acid is any of formulae (X-1) to (X-11) above, in which the E unit in the polyamic acid is any of formulae (E-21) to (E-36) below, and that has a group that is any of formulae (Z-1) to (Z-7) below as the Z unit in the polyamic acid.

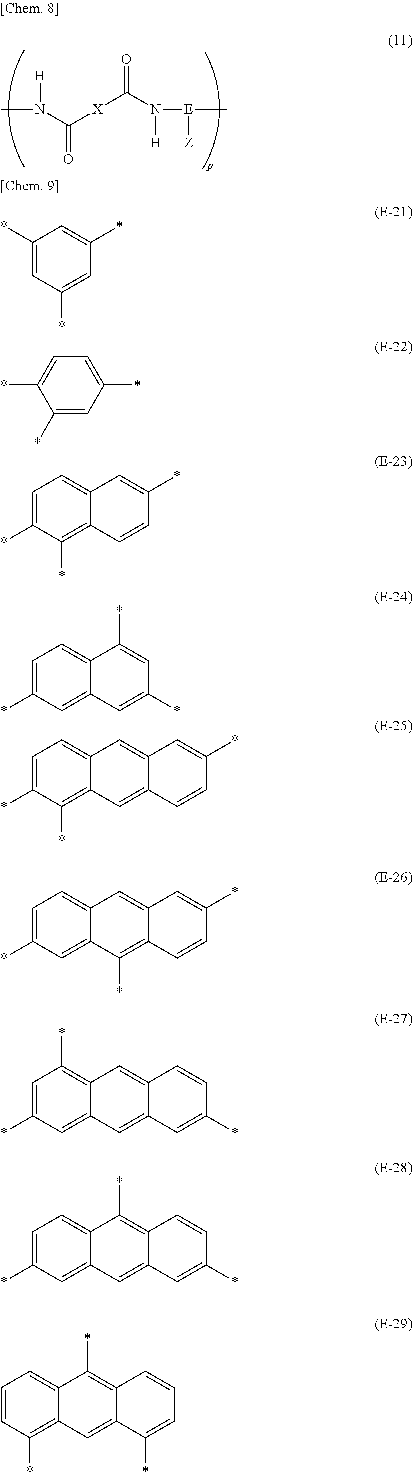

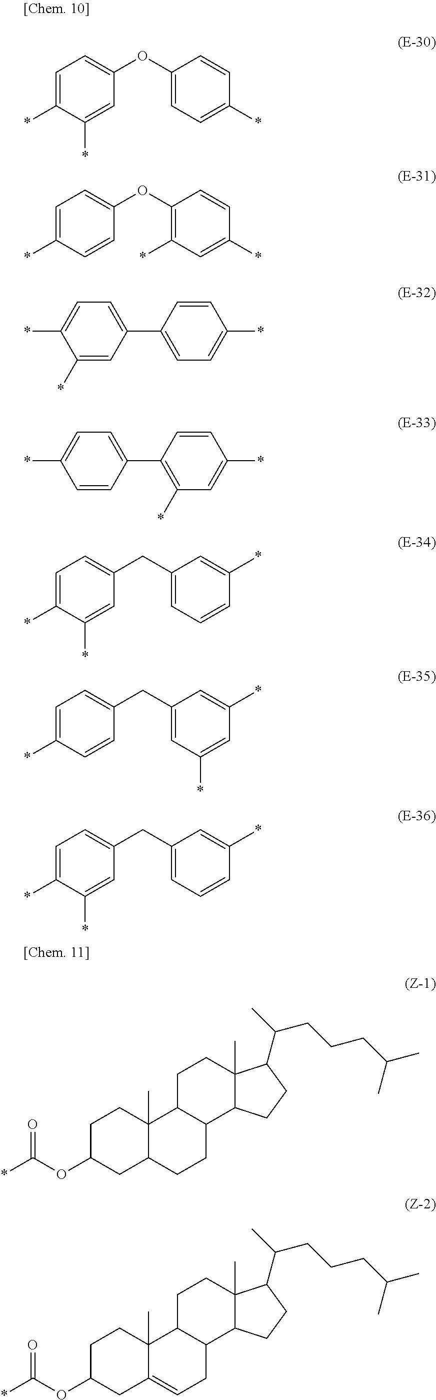

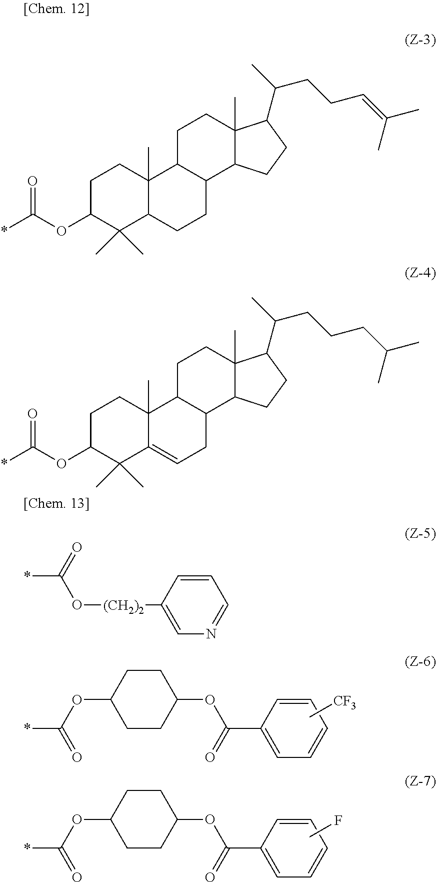

### (Second Polyamic Acid)

The second polyamic acid can be, for example, a copolymer of a “repeat unit having an alkoxysilyl group” (hereinafter repeat unit A) and a “repeat unit having no alkoxysilyl group” (hereinafter repeat unit B).

### (Repeat Unit A)

Repeat unit A can be, for example, one that has the polyamic acid structure represented by formula (11) above and in which the X unit in the polyamic acid is any of formulae (X-1) to (X-11) above, the E unit in the polyamic acid is any of formulae (E-21) to (E-36) above, and the side chain (Z unit) is formula (Z-200) below.

[Chem. 14]

*-A-Si(OR)₃ (Z-200)

(A in the formula represents a divalent organic group. R in the formula represents a C1-6 alkyl group. The multiple Rs may be the same or different.)

In formula (Z-200) above, A can be, for example, any of formulae (A-1) to (A-3) below.

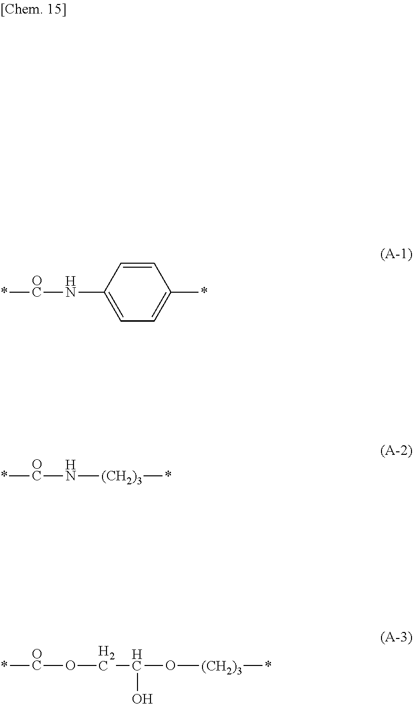

In formulae (A-1) to (A-3) above, the group is bound with the E unit at the binding site closer to the carbonyl group.

The Rs are preferably C1-4 alkyl groups, preferably C1-2 alkyl groups. To be more specific, it is preferred that —Si(OR)₃ be a trimethoxysilyl or triethoxysilyl group.

If repeat unit A has formula (E-21) above as the E unit, the group formed by the linkage of the E and Z units can be, for example, one that is any of formulae (E-201) to (E-206) below.

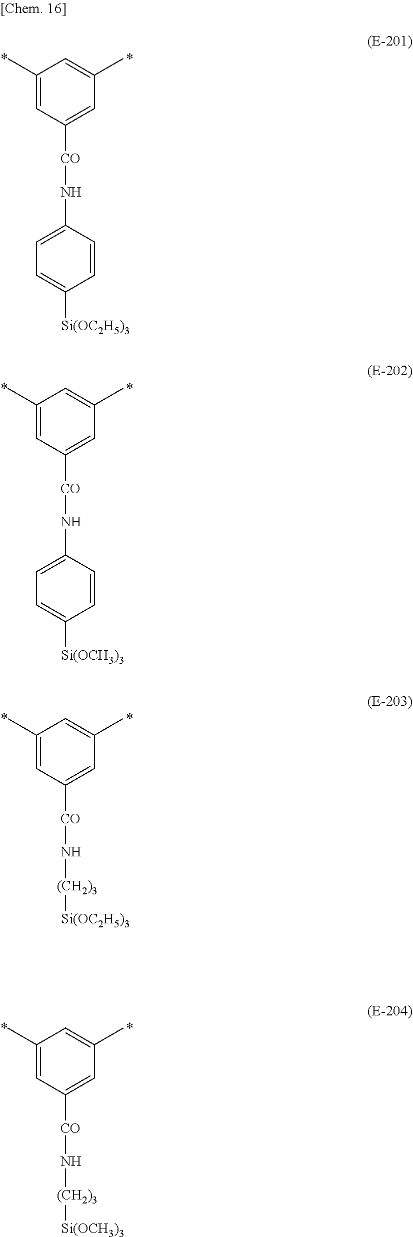

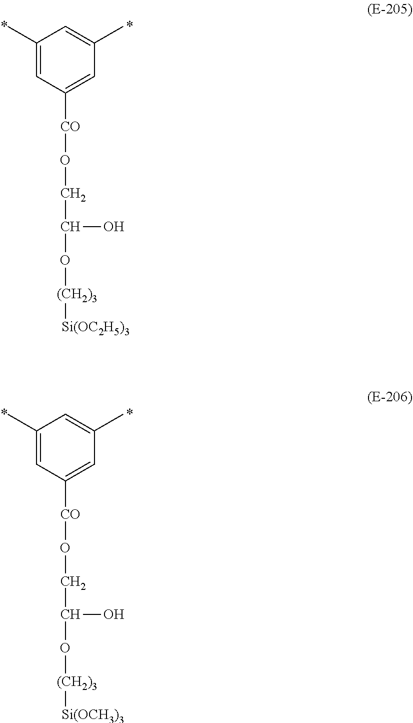

Of formulae (E-201) to (E-206) above, formulae (E-201) to (E-204), which have an amide group, are more polar than formulae (E-205) and (E-206), which have no amide group. The resulting high compatibility with the surface of the substrate ensures smooth spread over the surface of the substrate, and this makes formulae (E-201) to (E-204) preferred.

The X unit imidizes and produces a rigid imide group when heated. If the X unit has a group equivalent to formula (Z-200) above, therefore, the rigid backbone tends to restrict the movement of the group equivalent to formula (Z-200), preventing the advantages described hereinafter from accruing. This is the reason why in repeat unit A the alkoxysilyl group is bound with the E unit (is the Z unit).

### (Repeat Unit B)

Repeat unit B can be, for example, one that has the polyamic acid structure represented by formula (10) above and in which the X unit in the polyamic acid is any of formulae (X-1) to (X-11) below and in which the E unit in the polyamic acid is any of formulae (E-1) to (E-11) below.

In the second polyamic acid, repeat unit A is present in an amount of more than 0 mol % of all repeat units forming the second polyamic acid. Repeat unit A is present preferably in an amount of 2 mol % or more, more preferably 5 mol % or more, of all repeat units forming the second polyamic acid.

In the second polyamic acid, moreover, repeat unit A is present preferably in an amount of 40 mol % or less, more preferably 30 mol % or less, of all repeat units forming the second polyamic acid.

The upper and lower limits to the percentage (mol %) of repeat unit A in the second polyamic acid can be paired in any combination.

If the second polyamic acid contains more than 0 mol % repeat unit A with respect to all repeat units forming the second polyamic acid, the alkoxysilyl group reacts with and chemically binds to the surface of the substrate, ensuring easy separation of the composition into layers.

If repeat unit A is present in an amount of 40 mol % or less of all repeat units forming the second polyamic acid, the second polyamic acid contains the polar alkoxysilyl group but not so much that the resistance of the alignment film is too low. This helps prevent low VHR.

In a composition according to this embodiment, the proportion of the second polyamic acid to the total of the first and second polyamic acids is preferably 5% by mass or more, more preferably 30% by mass or more, even more preferably 50% by mass or more.

Likewise, the proportion of the second polyamic acid to the total of the first and second polyamic acids is preferably 95% by mass or less, more preferably 85% by mass or less, even more preferably 80% by mass or less.

These upper and lower limits can be paired in any combination.

By virtue of being such a mixture of a first polyamic acid and a second polyamic acid, a composition according to this embodiment has the following advantages.

First, when a composition of this embodiment is used to form an alignment film, a paint containing the composition is coated onto a substrate. The alkoxysilyl group the second polyamic acid has then reacts with and chemically binds to the surface of, for example, layers made from a resin material, such as an underlayer and an overcoat layer, an inorganic insulating layer made from a metal oxide, and an electrode made from an electrically conductive metal oxide on the substrate.

The second polyamic acid in the composition is therefore likely to form a layer closer to the substrate. The first polyamic acid, when compared with the second, is likely to form a layer farther away from the substrate than the layer containing the second polyamic acid. By virtue of this, the composition of this embodiment quickly separates into layers on the surface to which it is applied.

The first polyamic acid is designed to have a photoreactive functional group and/or a vertical alignment group so that its anchoring strength develops easily. When the composition smoothly separates into layers through the mechanism described above, therefore, the polyimide formed by the first polyamic acid is distributed closer to the liquid crystal layer effectively, helping the polyimide have anchoring strength to the liquid crystal composition.

As a result, a liquid crystal display device that includes alignment film(s) made from a composition of this embodiment leaks less light while in a black display. This helps pass and block light from the backlight as designed, thereby helping give the device a high contrast.

Second, alignment films made using a composition of this embodiment can be produced with less introduction of a photofunctional group. Monomers having a photofunctional group and polymers having a photofunctional group can affect image quality by dissolving in the liquid crystal layer.

The following describes, using formula (I) below, reactions that cause a loss of image quality. Formula (I) is for a monomer having a photofunctional group, but the same argument applies to a polymer having a photofunctional group.

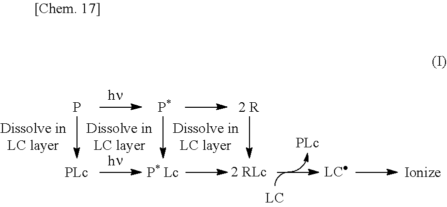

(P, a monomer having a photofunctional group; P*, the monomer having a photofunctional group in a photoexcited state; R, free radicals produced from the monomer having a photofunctional group; LC, liquid crystal molecules; LC., free radicals produced through the reaction of the liquid crystal molecules)

First, if an alignment film is formed using a composition of a monomer having a photofunctional group (polyamic acid) and a monomer having no photofunctional group, the monomer having a photofunctional group in the alignment film can produce free radicals through reaction before or after dissolving in the liquid crystal layer. The produced free radicals can produce free radicals of liquid crystal molecules by reacting with liquid crystal molecules. The free radicals of liquid crystal molecules produce ionic compounds by reacting with their surrounding substances. The produced ionic compounds reduce the specific resistance of the liquid crystal composition, causing low VHR.

Reducing the amount of the monomer having a photofunctional group to control the reactions represented by formula (I), however, can cause the alignment of the liquid crystal not to be the desired one because of insufficient anchoring strength.

By contrast, a composition according to an aspect of the present invention separates into a layer of a monomer having a photofunctional group (first polyamic acid) and a layer of a monomer having no photofunctional group (second polyamic acid) effectively. The photofunctional group is therefore positioned closer to the liquid crystal layer effectively. By virtue of this, efficient allocation of the photofunctional group closer to the liquid crystal layer ensures the development of anchoring strength even with a lower first polyamic acid content.

That is, a composition according to an aspect of the present invention helps reduce the decrease in VHR caused by the reactions of formula (I) because it can be produced with less monomer having a photofunctional group. By virtue of this, the composition helps prevent low VHR without affecting the specific resistance of the liquid crystal composition.

In a composition of this embodiment, the alkoxysilyl-containing repeat unit is present preferably in an amount of 0.05% by mass or more and 30% by mass or less of the whole composition.

The presence of 0.05% by mass or more alkoxysilyl-containing repeat unit in the whole composition ensures that the second polyamic acid reacts with and chemically binds to the surface of the substrate, ensuring easy separation of the composition into layers.

The presence of 30% by mass or less alkoxysilyl-containing repeat unit in the whole composition ensures that the second polyamic acid contains the polar alkoxysilyl group but not so much that the resistance of the alignment film is too low. This helps prevent low VHR.

The percentage of the alkoxysilyl-containing repeat unit to the whole composition can be measured as follows.

First, the first and second polyamic acids in the composition are separated by a known method, such as GPC. The chemical makeup of each is then analyzed by LC-MS.

Alternatively, the mass ratio between the first and second polyamic acids may be the value obtained as a result of the separation by GPC or any other method, or may be estimated from area ratios between functional groups in the NMR spectrum of each polyamic acid.

These measurement results can be used to calculate the percentage of the alkoxysilyl-containing repeat unit.

Overall, a composition of this embodiment enables easy production of high-performance liquid crystal display devices.

### Embodiment 2

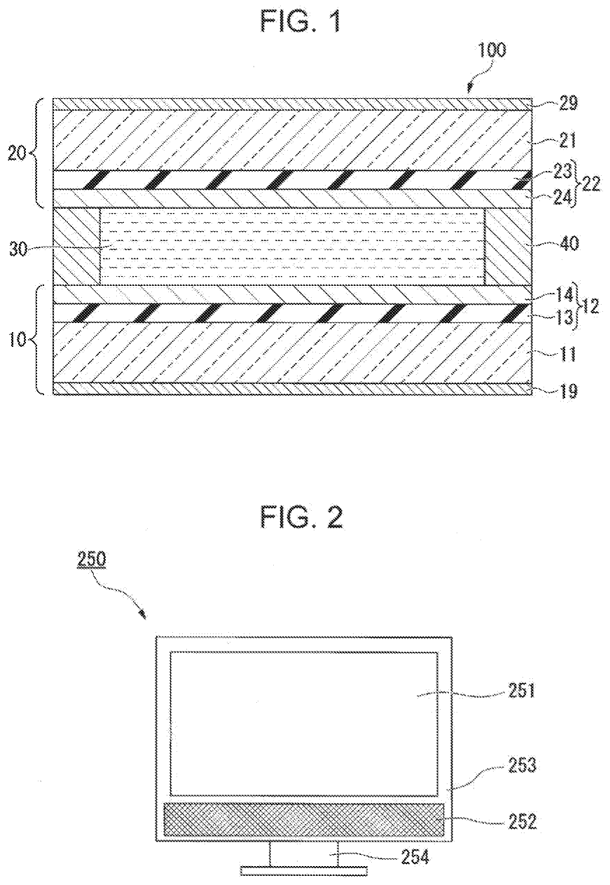

The following describes a liquid crystal display device according to Embodiment 2 of the present invention with reference to FIG. 1. It should be understood that in all drawings mentioned hereinafter, the dimensions, proportions, and other details of the individual elements may vary where appropriate for the sake of clarity.

### <Liquid Crystal Display Device>

FIG. 1 is a cross-sectional diagram schematically illustrating a liquid crystal display device of this embodiment. As illustrated in the drawing, the liquid crystal display device 100 of this embodiment has an element substrate 10, a counter substrate 20, a liquid crystal layer 30, and a seal section 40. The element and counter substrates 10 and 20 are the “pair of substrate” in an aspect of the present invention.

The device mode of the liquid crystal display device 100 of this embodiment is FFS (fringe field switching). The liquid crystal display device 100 is therefore a homogeneous-alignment liquid crystal display device.

The liquid crystal display device according to an aspect of the present invention, however, is not limited to homogeneous-alignment liquid crystal display devices but can be applied to liquid crystal display devices of various alignment technologies. Examples of alignment technologies of liquid crystal display devices to which it can be applied include TN (Twisted Nematic), STN (Super-Twisted Nematic), IPS (In Plane Switching), ECB (Electrically Controlled Birefringence), VA (Vertical Alignment), MVA (Multi Vertical Alignment), 4D-VTN (4-Domain Vertical TN), and 4D-VECB (4-Domain Vertical ECB).

### (Element Substrate)

The element substrate 10 has a TFT substrate 11, a first alignment film 12 on the surface of the TFT substrate 11 closer to the liquid crystal layer 30, and a first polarizer 19 on the side of the TFT substrate 11 opposite the liquid crystal layer 30.

The TFT substrate 11 has TFT elements for driving, not illustrated. The drain, gate, and source terminals of the driving TFT elements are electrically coupled to a pixel electrode, a gate bus line, and a source bus line, respectively. The pixels are electrically coupled by the electrical wiring of the source and gate bus lines.

The materials for the individual components of the TFT substrate 11 can be commonly known materials. The semiconductor layer of the driving TFTs is preferably made of IGZO (four-element mixed crystal semiconductor material containing indium (In), gallium (Ga), zinc (Zn), and oxygen (O)). When IGZO is used as a material for a semiconductor layer, the resulting semiconductor layer is limited in charge leakage by virtue of a small off-leakage current. This allows for a longer off period following the application of voltage to the liquid crystal layer. As a result, voltage is applied less frequently during the image display period, and the power consumption of the liquid crystal display device is reduced.

The TFT substrate 11 may be an active matrix one, which has a driving TFT for each pixel, or may be a simple matrix liquid crystal display device, in which each pixel does not have a TFT for driving it.

The first alignment film 12 is an alignment film made from a composition of Embodiment 1. The first alignment film 12 has a lower alignment film 13, which lies on the surface of the TFT substrate 11 closer to the liquid crystal layer 30, and an upper alignment film 14, which is in contact with the lower alignment film 13 and is on the surface of the lower alignment film 13.

The lower alignment film 13 contains the second polyamic acid that is in the composition of Embodiment 1.

The upper alignment film 14 contains the first polyamic acid that is in the composition of Embodiment 1.

The first polarizer 19 can be one that has a commonly known configuration.

### (Counter Substrate)

The counter substrate 20 has, for example, a color filter substrate 21, a second alignment film 22 on the surface of the color filter substrate 21 closer to the liquid crystal layer 30, and a second polarizer 29 on the side of the color filter substrate 21 opposite the liquid crystal layer 30.

The color filter substrate 21 has, for example, a red color filter layer, which absorbs part of incident light and allows red light to pass through, a green color filter layer, which absorbs part of incident light and allows green light to pass through, and a blue color filter layer, which absorbs part of incident light and allows blue light to pass through.

The color filter substrate 21 may further have an overcoat layer covering its surface to planarize the substrate surface and to prevent the dissolution of colorant materials out of the color filter layers.

The second alignment film 22 is an alignment film made from polymers including polyimides. The second alignment film 22 is, for example, a vertical alignment film.

The second alignment film 22 is an alignment film made from a composition of Embodiment 1. The second alignment film 22 has a lower alignment film 23, which lies on the surface of the color filter substrate 21 closer to the liquid crystal layer 30, and an upper alignment film 24, which is in contact with the lower alignment film 23 and is on the surface of the lower alignment film 23.

The lower alignment film 23 contains the second polyamic acid that is in the composition of Embodiment 1.

The upper alignment film 24 contains the first polyamic acid that is in the composition of Embodiment 1.

The second polarizer 29 can be one that has a commonly known configuration. The first and second polarizers 19 and 29 are in, for example, the crossed-Nicols arrangement.

### (Liquid Crystal Layer)

The liquid crystal layer 30 is made from a liquid crystal composition, a composition that contains a liquid crystal material. A liquid crystal material is a material that contains liquid crystal molecules, molecules that have liquid crystal properties.

The liquid crystal material may be totally liquid crystal molecules that exhibit liquid crystal properties alone or may be a composition that is a mixture of liquid crystal molecules that exhibit liquid crystal properties alone with an organic compound that does not exhibit liquid crystal properties alone. The composition exhibits liquid crystal properties as a whole. The liquid crystal material is a negative liquid crystal, a liquid crystal with negative dielectric anisotropy.

The liquid crystal material preferably contains liquid crystal molecules having a functional group represented by formula (B) below.

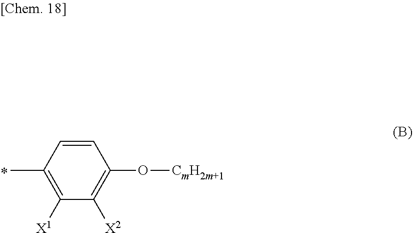

(In the formula, X1 and X2 each independently represent a hydrogen atom, fluorine atom, or atom.

m is any integer of 1 to 18.)

Examples of liquid crystal molecules that can be used include formulae (B-1) to (B-5) below.

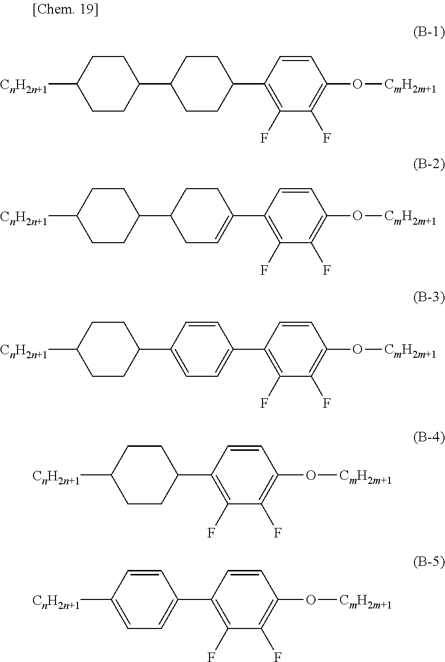

(In the formulae, m is any integer of 1 to 18.)

The liquid crystal material preferably contains at least one compound (alkenyl compound) selected from the group consisting of formulae (C-1) to (C-4) below. Such alkenyl compounds improve the response speed of the liquid crystal material containing them. A liquid crystal layer made with a liquid crystal material containing any such alkenyl compound therefore gives the liquid crystal display device a high image quality.

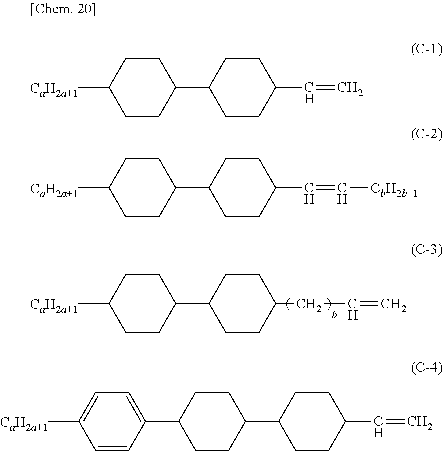

(In the formulae, a and b are any integers of 1 to 6 independent from each other.)

An example of such a compound is the compound represented by formula (C-10) below. The compound represented by formula (C-10) below is a compound represented by formula (C-1) above and the form where a=3.

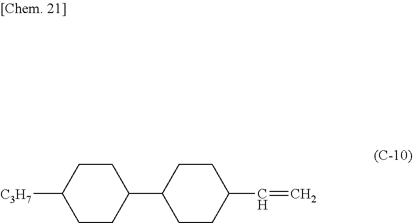

### (Seal Section)

The seal section 40 is sandwiched between the element and counter substrates 10 and 20 and surrounds the liquid crystal layer 30. The seal section 40 is in contact with the liquid crystal composition, the material forming the liquid crystal layer 30, and prevents the liquid crystal composition from leaking.

The seal section 40 is made from a curable resin composition. The curable resin composition can be of any type as long as it has ultraviolet-responsive and thermoresponsive functional groups. One that has one or both of the (meth)acryloyl and epoxy groups is preferred because it cures quickly and exhibits good bonding properties when the curable resin composition is used as a sealant for one-drop filling (ODF).

Examples of such curable resin compositions include (meth)acrylates and epoxy resins. These resins may be used alone, or two or more may be used in combination. (Meth)acrylic as used herein means acrylic or methacrylic.

Any kind of (meth)acrylate can be used, and examples include urethane (meth)acrylates, which have urethane linkages, and epoxy (meth)acrylates, which are derived from a compound having a glycidyl group and (meth)acrylic acid.

Any kind of urethane (meth)acrylate can be used, and examples include derivatives of a diisocyanate, such as isophorone diisocyanate, and a reactive compound that undergoes addition reaction with isocyanates, such as acrylic acid or hydroxyethyl acrylate. Chain-extended versions of these derivatives, for example extended with caprolactone or a polyol, may also be used. Examples of commercially available urethane (meth)acrylates include U-122P, U-340P, U-4HA, and U-1084A (Shin-Nakamura Chemical); and KRM7595, KRM7610, and KRM7619 (Daicel UCB).

Any kind of epoxy (meth)acrylate can be used, and examples include epoxy (meth)acrylates derived from an epoxy resin, such as a bisphenol-A epoxy resin or propylene glycol diglycidyl ether, and (meth)acrylic acid. Examples of commercially available epoxy (meth)acrylates include EA-1020, EA-6320, and EA-5520 (Shin-Nakamura Chemical); and EPOXY ESTER 70PA and EPOXY ESTER 3002A (Kyoeisha Chemical).

Examples of other (meth)acrylates include methyl methacrylate, tetrahydrofurfuryl methacrylate, benzyl methacrylate, isobornyl methacrylate, 2-hydroxyethyl methacrylate, glycidyl methacrylate, (poly)ethylene glycol dimethacrylate, 1,4-butanediol dimethacrylate, 1,6-hexanediol dimethacrylate, trimethylolpropane triacrylate, pentaerythritol triacrylate, and glycerol dimethacrylate.

Examples of epoxy resins include phenol-novolac epoxy resins, cresol-novolac epoxy resins, biphenyl-novolac epoxy resins, trisphenol-novolac epoxy resins, dicyclopentadiene-novolac epoxy resins, bisphenol-A epoxy resins, bisphenol-F epoxy resins, 2,2′-diallylbisphenol-A epoxy resins, bisphenol-S epoxy resins, hydrogenated-bisphenol-A epoxy resins, bisphenol-A-propylene-oxide-adduct epoxy resins, biphenyl epoxy resins, naphthalene epoxy resins, resorcinol epoxy resins, and glycidyl amines.

An example of a commercially available phenyl-novolac epoxy resin is NC-3000S (Nippon Kayaku).

Examples of commercially available trisphenol-novolac epoxy resins include EPPN-501H and EPPN-501H (Nippon Kayaku).

An example of a commercially available dicyclopentadiene-novolac epoxy resin is NC-7000L (Nippon Kayaku).

Examples of commercially available bisphenol-A epoxy resins include EPICLON 840S and EPICLON 850CRP (Dainippon Ink and Chemicals).

Examples of commercially available bisphenol-F epoxy resins include Epikote 807 (Japan Epoxy Resins) and EPICLON 830 (Dainippon Ink and Chemicals).

An example of a commercially available 2,2′-diallylbisphenol-A epoxy resin is RE310NM (Nippon Kayaku).

An example of a commercially available hydrogenated-bisphenol epoxy resin is EPICLON 7015 (Dainippon Ink and Chemicals).

An example of a commercially available bisphenol-A-propylene-oxide-adduct epoxy resin is EPOXY ESTER 3002A (Kyoeisha Chemical).

Examples of commercially available biphenyl epoxy resins include Epikote YX-4000H and YL-6121H (Japan Epoxy Resins).

An example of a commercially available naphthalene epoxy resin is EPICLON HP-4032 (Dainippon Ink and Chemicals).

An example of a commercially available resorcinol epoxy resin is Denacol EX-201 (Nagase ChemteX).

Examples of glycidyl amines include EPICLON 430 (Dainippon Ink and Chemicals) and Epikote 630 (Japan Epoxy Resins).

Epoxy/(meth)acrylic resins, resins having at least one (meth)acrylic group and at least one or more epoxy groups per molecule, are also suitable curable resin compositions.

Examples of epoxy/(meth)acrylic resins include compounds obtained by reacting a subset of the epoxy groups of an epoxy resin with (meth)acrylic acid in the presence of a basic catalyst by the ordinary method, compounds obtained by reacting one mole of an isocyanate that has two or more isocyanate groups with ½ moles of a hydroxy-containing (meth)acrylic monomer and then with ½ moles of glycidol, and compounds obtained by reacting an isocyanate-containing (meth)acrylate with glycidol. An example of a commercially available epoxy/(meth)acrylic resin is UVAC1561 (Daicel UCB).

The curable resin composition forming the seal section 40 may contain a silane coupling agent. A silane coupling agent in the curable resin composition helps improve the adhesion between the seal section 40 and the substrates (element and counter substrates 10 and 20).

The silane coupling agent can be of any type. Examples of suitable silane couplings agents include γ-aminopropyltrimethoxysilane, γ-mercaptopropyltrimethoxysilane, γ-glycidoxypropyltrimethoxysilane, and γ-isocyanatopropyltrimethoxisilane and those coupling agents that are imidazole silane compounds, which are formed by an imidazole structure and an alkoxysilyl group joined together by a spacer group. One of these may be used alone, or two or more may be used in combination.

The curable resin composition forming the seal section 40 may contain filler, for example for improving adhesiveness by stress distribution and for improving the coefficient of linear expansion, unless it goes against the objects of the present invention.

Any kind of filler can be used. Examples include inorganic fillers, such as silica, diatomaceous earth, alumina, zinc oxide, iron oxide, magnesium oxide, tin oxide, titanium oxide, magnesium hydroxide, aluminum hydroxide, magnesium carbonate, barium sulfate, gypsum, calcium silicate, talc, glass beads, sericite activated clay, bentonite, aluminum nitride, and silicon nitride.

Besides these ingredients, the curable resin composition forming the seal section 40 may contain a gelling agent and/or a photosensitizer for use in photoreaction.

Besides the components described, the liquid crystal display device 100 may have a spacer, a pillar-like structure for determining the thickness of the liquid crystal layer 30.

As mentioned above, the first and second alignment films 12 and 22 are alignment films made from a composition of Embodiment 1 and formed by separating this composition into layers.

If the multilayer structure of the first and second alignment films 12 and 22 were constructed by forming and stacking one layer after another, the upper alignment film would not contain the material forming the lower alignment film, i.e., the polyimide derived from the second polyamic acid, and the lower alignment film would not contain the material forming the upper alignment film, i.e., the polyimide derived from the first polyamic acid.

The one-after-another formation of layers would therefore result in the amount of the alkoxysilyl group of the second polyamic acid in the first alignment film 12, for example, as measured in the thickness direction being discontinuous at the interface between the upper and lower alignment films 14 and 13.

In the second alignment film 22, the amount of the alkoxysilyl group of the second polyamic acid as measured in the thickness direction would be discontinuous at the interface between the upper and lower alignment films 24 and 23. The alignment films would therefore be different than in an aspect of the present invention.

The first alignment film 12 according to an aspect of the present invention, by contrast, is made with a composition as described above and has a layer structure formed using layer separation. In this film, the percentage of the alkoxysilyl group tapers off with increasing distance from the TFT substrate 11. In the second alignment film 22, the percentage of the alkoxysilyl group tapers off with increasing distance from the color filter substrate 21.

The target of analysis does not need to be the alkoxysilyl group but may be any other substituent from which the presence of the first or second polyamic acid can be traced. By tracing the presence of the first or second polyamic acid in this way, it is possible to determine whether or not an alignment film has been made using a composition according to an aspect of the present invention.

In each of the first and second alignment films 12 and 22 of a liquid crystal display device of this embodiment, the alkoxysilyl-containing repeat unit is present preferably in an amount of 0.05% by mass or more and 30% by mass or less of the whole alignment film.

The presence of 0.05% by mass or more alkoxysilyl-containing repeat unit in the whole alignment film ensures that the lower alignment film reacts with and chemically binds to the surface of the substrate easily, ensuring easy separation of the composition into layers.

The presence of 30% by mass or less alkoxysilyl-containing repeat unit in the whole alignment film for each of the first and second alignment films 12 and 22 ensures that the alignment films contain the polar alkoxysilyl group but not so much that their resistance is too low. This helps prevent low VHR.

The percentage of the alkoxysilyl-containing repeat unit to the whole alignment film for each of the first and second alignment films 12 and 22 can be measured as follows.

First, the first or second alignment film 12 or 22 is processed to collect each of its upper alignment film, positioned closer to the surface of the alignment film, and its lower alignment film, positioned closer to the substrate in the alignment film. The chemical makeup of each of the collected upper and lower alignment films is analyzed by LC-MS.

Alternatively, the NMR spectrum of the upper and lower alignment films also provides the basis. The mass of the alkoxysilyl-containing repeat unit is estimated from area ratios between functional groups.

These measurement results can be used to calculate the percentage of the alkoxysilyl-containing repeat unit.

By virtue of including alignment films made from a composition as described above, a liquid crystal display device having such a configuration is a high-performance liquid crystal display device.

### Embodiment 3

### <Electronic Apparatuses>

FIGS. 2 to 5 are schematic diagrams illustrating electronic apparatuses of this embodiment. Electronic apparatuses of this embodiment have a liquid crystal panel as described above and a controller that supplies a driving signal to the liquid crystal panel.

The flat-panel TV 250 illustrated in FIG. 2 includes a display unit 251, loudspeakers 252, a cabinet 253, a stand 254, etc. A liquid crystal display device as described above is suitable for use as the display unit 251. By virtue of this, the flat-panel TV 250 can achieve good display quality with high contrast.

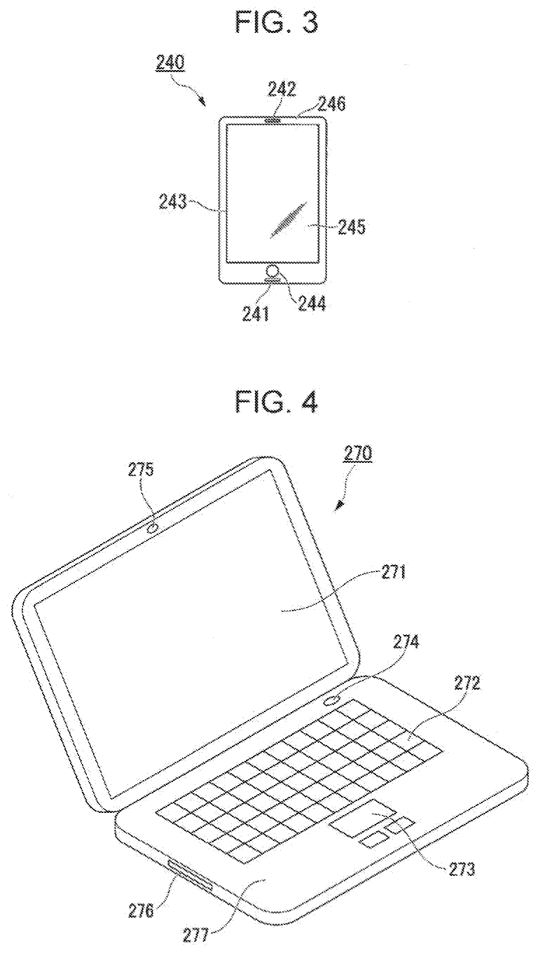

The smartphone 240 illustrated in FIG. 3 includes an audio input unit 241, an audio output unit 242, a control switch 244, a display unit 245, a touchscreen 243, an enclosure 246, etc. A liquid display device as described above is suitable for use as the display unit 245. By virtue of this, the smartphone 240 can achieve good display quality with high contrast.

The laptop computer 270 illustrated in FIG. 4 includes a display unit 271, a keyboard 272, a touchpad 273, a main switch 274, a camera 275, a recording medium slot 276, an enclosure 277, etc.

A liquid crystal display device as described above is suitable for use as the display unit 271. By virtue of this, the laptop computer 270 can achieve good display quality with high contrast.

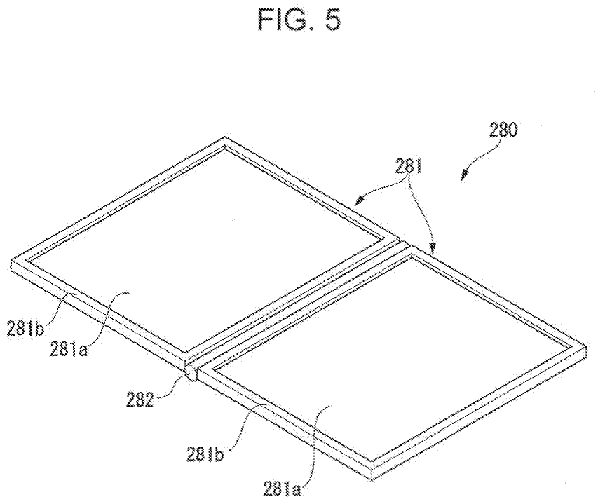

The mobile electronic device 280 illustrated in FIG. 5 has two display units 281 and a hinge mechanism 282 that connects the two display units 281 together. The hinge mechanism 282 allows the display units 281 to fold. The display units 281 have a display panel 281a and an enclosure 281b. A liquid crystal panel as described above is suitable for use as the display panel 281a. By virtue of this, the mobile electronic device 280 can achieve good display quality with high contrast.

There may be curved lenses on the display units 281. Lenses allow the images on the two display units 281 to be displayed seamlessly.

Electronic apparatuses of this embodiment use liquid crystal display device(s) as described above as display unit(s). By virtue of this, electronic apparatuses of this embodiment achieve good display quality with high contrast.

Having described preferred embodiments of the present invention with reference to the accompanying drawings, it goes without saying that the present invention is not limited to these examples. The shapes, combinations, and other details of the individual components presented in the above examples are merely illustrative, and various modifications can be made according to design requirements or other conditions without departing from the spirit of the present invention.

### EXAMPLES

The following describes the present invention by examples, but the present invention is not limited to these examples.

Liquid crystal cells of Examples and Comparative Examples prepared as described hereinafter were tested regarding characteristics as follows.

### (Contrast)

Contrast was measured in a dark room using Topcon SR-UL1 luminance meter.

Measuring temperature, 25° C.; wavelength range scanned, 380 to 780 nm

### (Response Performance)

Response performance was measured using Photal 5200 (Otsuka Electronics).

Measuring temperature, 25° C.; voltage varied between a transmittance of 0.5 to the maximum transmittance

### (VHR (Voltage Holding Ratio))

The VHR was measured using TOYO Corporation Model 6254 VHR measurement system under the conditions of 1 V and 70° C. The VHR represents what percentage of stored charge is retained during one frame period. Liquid crystal display devices with higher VHRs can be considered better.

### (Durability Test)

Each of the liquid crystal cells obtained was exposed to light from a backlight for 1000 hours in an oven at 70° C. VHRs measured before and after the durability test were used to evaluate durability.

### Test 1

### Example 1-1

A paint containing a mixture of a first polyamic acid and a second polyamic acid was coated onto one surface of a substrate having ITO electrodes for the FFS mode (hereinafter referred to as substrate A) and of a counter substrate having no electrodes (hereinafter referred to as substrate B).

The first polyamic acid was the polyamic acid represented by formula (101) below.

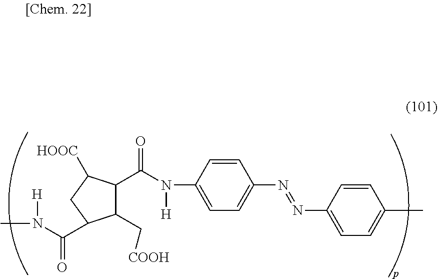

(In the formula, p represents an integer)

The second polyamic acid was a polyamic acid having the repeat unit represented by formula (102) below and the repeat unit represented by formula (103) below. The repeat unit represented by formula (102) below is a “repeat unit having an alkoxysilyl group,” and the repeat unit represented by formula (103) below is a “repeat unit having no alkoxysilyl group.”

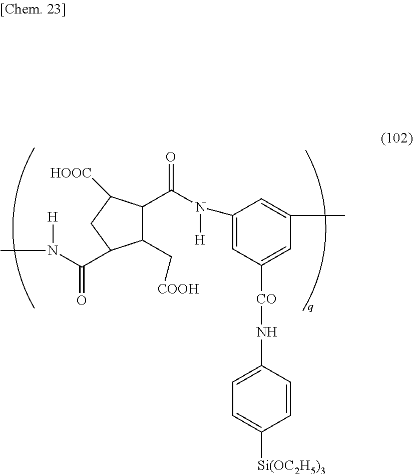

(In the formula, q represents an integer)

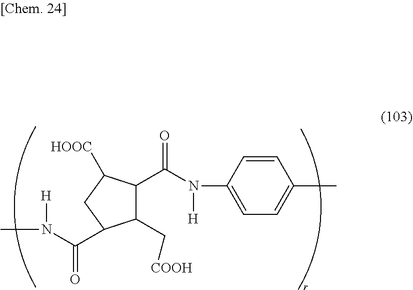

(In the formula, r represents an integer)

The percentage of the first polyamic acid to the total of the first and second polyamic acids was 30% by mass. The percentage of the second polyamic acid was 70% by mass.

In the second polyamic acid, the percentage of the repeat unit represented by formula (102) above to the total of the repeat units represented by formulae (102) and (103) above was 2 mol %.

The coatings were then fired at 80° C. for 2 minutes and then irradiated with 2 J/cm² of linearly polarized light including ultraviolet light with wavelengths between 310 and 450 nm along the normal to the substrates.

The coatings were then fired at 120° C. for 20 minutes and then at 230° C. for 40 minutes to complete photoalignment films.

Then a pattern was drawn with a sealant (ultraviolet curable+thermosetting sealant; product name, Photolec; Sekisui Chemical Co., Ltd.) on the photoalignment film side of substrate A. Separately, a drop of a positive liquid crystal material with a Tni (nematic-isotropic phase transition temperature) of 85° C. was put onto the photoalignment film side of substrate B.

After the two substrates were joined together in a vacuum, the sealant was cured by irradiating it with light including ultraviolet light with wavelengths between 340 and 450 nm. The workpiece was then heated at 130° C. for 40 minutes for thermal curing of the sealant and reorientation of the liquid crystal layer, completing a test cell of Example 1-1 for liquid crystal display devices (liquid crystal cell).

### Example 1-2

A test cell of Example 1-2 for liquid crystal display devices (liquid crystal cell) was obtained in the same way as in Example 1-1 except that the percentage of the repeat unit represented by formula (102) above to the total of the repeat units represented by formulae (102) and (103) above in the second polyamic acid was changed to 10 mol %.

### Example 1-3

A test cell of Example 1-3 for liquid crystal display devices (liquid crystal cell) was obtained in the same way as in Example 1-1 except that the percentage of the repeat unit represented by formula (102) above to the total of the repeat units represented by formulae (102) and (103) above in the second polyamic acid was changed to 30 mol %.

### Example 1-4

A test cell of Example 1-4 for liquid crystal display devices (liquid crystal cell) was obtained in the same way as in Example 1-1 except that the percentage of the repeat unit represented by formula (102) above to the total of the repeat units represented by formulae (102) and (103) above in the second polyamic acid was changed to 40 mol %.

### Comparative Example 1-1

A test cell of Comparative Example 1-1 for liquid crystal display devices (liquid crystal cell) was obtained in the same way as in Example 1-1 except that the percentage of the repeat unit represented by formula (102) above to the total of the repeat units represented by formulae (102) and (103) above in the second polyamic acid was changed to 0 mol %.

Table 1 is a table that presents test results for <Test 1>.

TABLE 1

| | Percentage | Response | | VHR | |
|---|---|---|---|---|---|
| | of formula | performance | | Before | After |
| | (102) | (τr + τd) | | durability | durability |
| | (mol %) | (ms) | Contrast | test | test |
| Example 1-1 | 2 | 27 | 1300 | 99.5 | 99.2 |
| Example 1-2 | 10 | 27 | 1500 | 99.5 | 99.2 |
| Example 1-3 | 30 | 27 | 1500 | 99.5 | 99.1 |
| Example 1-4 | 40 | 27 | 1400 | 99.3 | 98.6 |
| Comparative | 0 | 27 | 1000 | 99.5 | 99.1 |
| Example 1-1 | | | | | |

The test revealed that introducing such an alkoxysilyl-containing repeat unit as represented by formula (102) above increases contrast.

Introducing an alkoxysilyl-containing repeat unit ensures effective separation of the composition into layers, a layer containing the first polyamic acid and a layer containing the second polyamic acid. A photoalignment functional group is distributed in more abundance closer to the liquid crystal layer, making the alignment of molecules in the alignment films by photoalignment (irradiation with linearly polarized UV) more effective. As a result, the inventors believe, liquid crystal molecules are aligned better, less light leaks during a black display, and the display blackens (lightness decreases).

That is, the introduction of an alkoxysilyl-containing repeat unit increases the difference between the lightness during a black display and that during a white display, thereby increasing contrast.

Example 1-4, in which the amount of introduced repeat unit represented by formula (102) above was 40 mol %, was found to improve contrast but cause a slight decrease in durability.

It is therefore preferred that the amount of introduced repeat unit represented by formula (102) above be less than 40 mol %. Introducing much of the repeat unit represented by formula (102) above, the inventors believe, causes more alcohol to be produced by reaction between a silane coupling agent and the carboxylic acids in the polyamic acids, thereby affecting durability.

### Test 2

### Example 2-1

A paint containing a mixture of a first polyamic acid and a second polyamic acid was coated onto one surface of substrates A and B.

The first polyamic acid was the polyamic acid represented by formula (201) below.

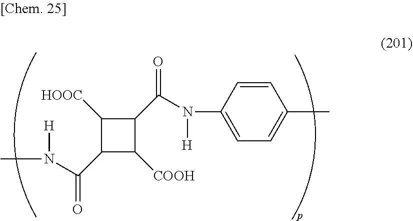

(In the formula, p represents an integer)

The second polyamic acid was a polyamic acid having the repeat unit represented by formula (202) below and the repeat unit represented by formula (203) below. The repeat unit represented by formula (202) below is a “repeat unit having an alkoxysilyl group,” and the repeat unit represented by formula (203) below is a “repeat unit having no alkoxysilyl group.”

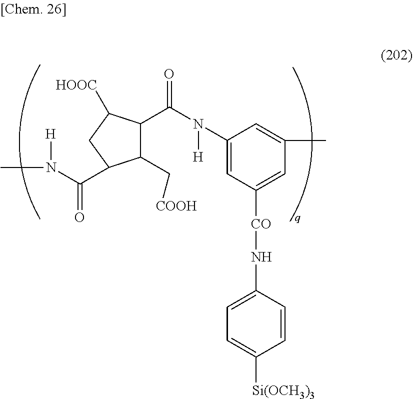

(In the formula, q represents an integer)

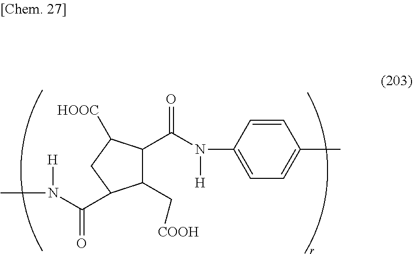

(In the formula, r represents an integer)

The percentage of the first polyamic acid to the total of the first and second polyamic acids was 20% by mass. The percentage of the second polyamic acid was 80% by mass.

In the second polyamic acid, the percentage of the repeat unit represented by formula (202) above to the total of the repeat units represented by formulae (202) and (203) above was 2 mol %.

The coatings were then fired at 80° C. for 2 minutes, then at 200° C. for 40 minutes, and then irradiated with 200 mJ/cm² of linearly polarized light including ultraviolet light with wavelengths between 250 and 300 nm along the normal to the substrates.

The coatings were then fired at 200° C. for 20 minutes to complete photoalignment films.

Then a pattern was drawn with a sealant (ultraviolet curable+thermosetting sealant; product name, Photolec; Sekisui Chemical Co., Ltd.) on the photoalignment film side of substrate A. Separately, a drop of a positive liquid crystal material with a Tni of 85° C. was put onto the photoalignment film side of substrate B.

After the two substrates were joined together in a vacuum, the sealant was cured by irradiating it with light including ultraviolet light with wavelengths between 340 and 450 nm. The workpiece was then heated at 130° C. for 40 minutes for thermal curing of the sealant and reorientation of the liquid crystal layer, completing a test cell of Example 2-1 for liquid crystal display devices (liquid crystal cell).

### Example 2-2

A test cell of Example 2-2 for liquid crystal display devices (liquid crystal cell) was obtained in the same way as in Example 2-1 except that the percentage of the repeat unit represented by formula (202) above to the total of the repeat units represented by formulae (202) and (203) above in the second polyamic acid was changed to 10 mol %.

### Example 2-3

A test cell of Example 2-3 for liquid crystal display devices (liquid crystal cell) was obtained in the same way as in Example 2-1 except that the percentage of the repeat unit represented by formula (202) above to the total of the repeat units represented by formulae (202) and (203) above in the second polyamic acid was changed to 30 mol %.

### Example 2-4

A test cell of Example 2-4 for liquid crystal display devices (liquid crystal cell) was obtained in the same way as in Example 2-1 except that the percentage of the repeat unit represented by formula (202) above to the total of the repeat units represented by formulae (202) and (203) above in the second polyamic acid was changed to 40 mol %.

### Comparative Example 2-1

A test cell of Comparative Example 2-1 for liquid crystal display devices (liquid crystal cell) was obtained in the same way as in Example 2-1 except that the percentage of the repeat unit represented by formula (202) above to the total of the repeat units represented by formulae (202) and (203) above in the second polyamic acid was changed to 0 mol %.

Table 2 is a table that presents test results for <Test 2>.

TABLE 2

| | Percentage | Response | | VHR | |
|---|---|---|---|---|---|
| | of formula | performance | | Before | After |
| | (202) | (τr + τd) | | durability | durability |
| | (mol %) | (ms) | Contrast | test | test |
| Example 2-1 | 2 | 27 | 1250 | 99.5 | 99.2 |
| Example 2-2 | 10 | 27 | 1400 | 99.5 | 99.5 |
| Example 2-3 | 30 | 27 | 1420 | 99.5 | 99.5 |
| Example 2-4 | 40 | 27 | 1330 | 99.5 | 99.0 |
| Comparative | 0 | 27 | 900 | 99.5 | 99.4 |
| Example 2-1 | | | | | |

The test revealed that introducing such an alkoxysilyl-containing repeat unit A as represented by formula (202) above increases contrast.

Example 2-4, moreover, in which the percentage of the repeat unit represented by formula (202) above was 40 mol %, was found to improve contrast but cause a slight decrease in durability.

It is therefore preferred that the amount of introduced repeat unit represented by formula (202) above be less than 40 mol %.

### Test 3

### Example 3-1

A paint containing a mixture of a first polyamic acid and a second polyamic acid was coated onto one surface of substrates A and B.

The first polyamic acid was the polyamic acid represented by formula (301) below.

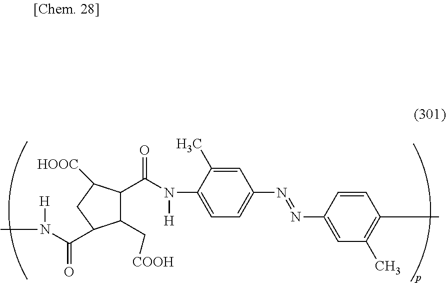

(In the formula, p represents an integer)

The second polyamic acid was a polyamic acid having the repeat unit represented by formula (302) below and the repeat unit represented by formula (303) below. The repeat unit represented by formula (302) below is a “repeat unit having an alkoxysilyl group,” and the repeat unit represented by formula (303) below is a “repeat unit having no alkoxysilyl group.”

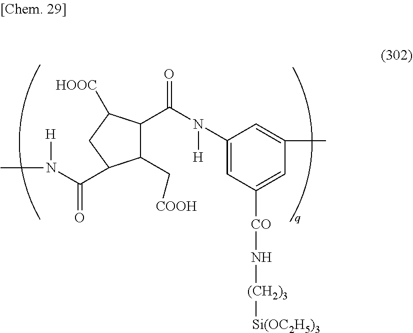

(In the formula, q represents an integer)

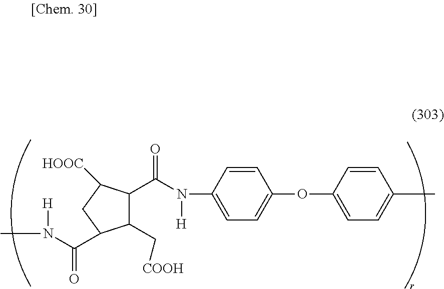

(In the formula, r represents an integer)

The percentage of the first polyamic acid to the total of the first and second polyamic acids was 25% by mass. The percentage of the second polyamic acid was 75% by mass.

In the second polyamic acid, the percentage of the repeat unit represented by formula (302) above to the total of the repeat units represented by formulae (302) and (303) above was 2 mol %.

The coatings were then fired at 80° C. for 2 minutes and then irradiated with 2 J/cm² of linearly polarized light including ultraviolet light with wavelengths between 310 and 450 nm along the normal to the substrates.

The coatings were then fired at 175° C. for 20 minutes and then at 230° C. for 20 minutes to complete photoalignment films.

Then a pattern was drawn with a sealant (ultraviolet curable+thermosetting sealant; product name, Photolec; Sekisui Chemical Co., Ltd.) on the photoalignment film side of substrate A. Separately, a drop of a positive liquid crystal material with a Tni of 95° C. was put onto the photoalignment film side of substrate B.

After the two substrates were joined together in a vacuum, the sealant was cured by irradiating it with light including ultraviolet light with wavelengths between 340 and 450 nm. The workpiece was then heated at 130° C. for 40 minutes for thermal curing of the sealant and reorientation of the liquid crystal layer, completing a test cell of Example 3-1 for liquid crystal display devices (liquid crystal cell).

### Example 3-2

A test cell of Example 3-2 for liquid crystal display devices (liquid crystal cell) was obtained in the same way as in Example 3-1 except that the percentage of the repeat unit represented by formula (302) above to the total of the repeat units represented by formulae (302) and (303) above in the second polyamic acid was changed to 10 mol %.

### Example 3-3

A test cell of Example 3-3 for liquid crystal display devices (liquid crystal cell) was obtained in the same way as in Example 3-1 except that the percentage of the repeat unit represented by formula (302) above to the total of the repeat units represented by formulae (302) and (303) above in the second polyamic acid was changed to 30 mol %.

### Example 3-4

A test cell of Example 3-4 for liquid crystal display devices (liquid crystal cell) was obtained in the same way as in Example 3-1 except that the percentage of the repeat unit represented by formula (302) above to the total of the repeat units represented by formulae (302) and (303) above in the second polyamic acid was changed to 40 mol %.

### Comparative Example 3-1

A test cell of Comparative Example 3-1 for liquid crystal display devices (liquid crystal cell) was obtained in the same way as in Example 3-1 except that the percentage of the repeat unit represented by formula (302) above to the total of the repeat units represented by formulae (302) and (303) above in the second polyamic acid was changed to 0 mol %.

Table 3 is a table that presents test results for <Test 3>.

TABLE 3

| | Percentage | Response | | VHR | |
|---|---|---|---|---|---|
| | of formula | performance | | Before | After |
| | (302) | (τr + τd) | | durability | durability |
| | (mol %) | (ms) | Contrast | test | test |
| Example 3-1 | 2 | 16 | 1400 | 99.5 | 99.0 |
| Example 3-2 | 10 | 16 | 1500 | 99.5 | 99.2 |
| Example 3-3 | 30 | 16 | 1500 | 99.5 | 99.2 |
| Example 3-4 | 40 | 16 | 1370 | 99.3 | 98.1 |
| Comparative | 0 | 16 | 1100 | 99.5 | 99.0 |
| Example 3-1 | | | | | |

The test revealed that introducing such an alkoxysilyl-containing repeat unit A as represented by formula (302) above increases contrast.

Example 3-4, moreover, in which the percentage of the repeat unit represented by formula (302) above was 40 mol %, was found to improve contrast but cause a slight decrease in durability.

It is therefore preferred that the amount of introduced repeat unit represented by formula (302) above be less than 40 mol %.

### Test 4

### Example 4-1

A paint containing a mixture of a first polyamic acid and a second polyamic acid was coated onto one surface of substrates A and B.

The first polyamic acid was the polyamic acid represented by formula (401) below.

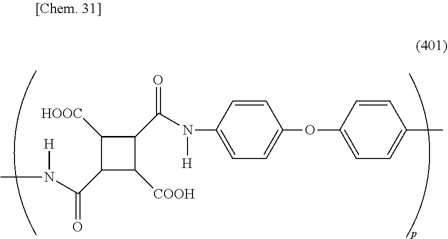

(In the formula, p represents an integer)

The second polyamic acid was a polyamic acid having the repeat unit represented by formula (402) below and the repeat unit represented by formula (403) below. The repeat unit represented by formula (402) below is a “repeat unit having an alkoxysilyl group,” and the repeat unit represented by formula (403) below is a “repeat unit having no alkoxysilyl group.”

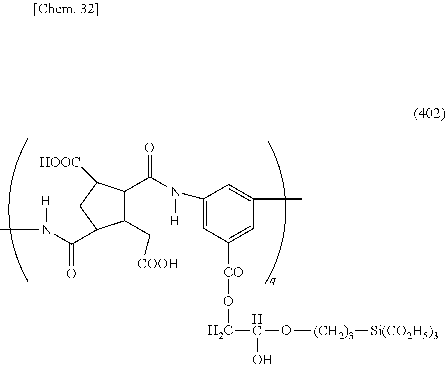

(In the formula, q represents an integer)

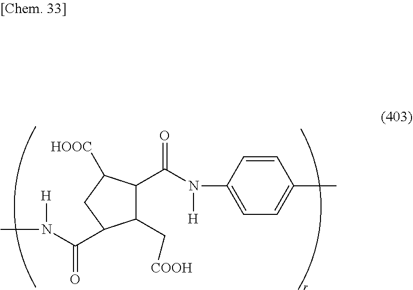

(In the formula, r represents an integer)

The percentage of the first polyamic acid to the total of the first and second polyamic acids was 20% by mass. The percentage of the second polyamic acid was 80% by mass.

In the second polyamic acid, the percentage of the repeat unit represented by formula (402) above to the total of the repeat units represented by formulae (402) and (403) above was 30 mol %.

The coatings were then fired at 80° C. for 2 minutes, then at 200° C. for 40 minutes, and then irradiated with 200 mJ/cm² of linearly polarized light including ultraviolet light with wavelengths between 250 and 300 nm along the normal to the substrates.

The coatings were then fired at 200° C. for 20 minutes to complete photoalignment films.

Then a pattern was drawn with a sealant (ultraviolet curable+thermosetting sealant; product name, Photolec; Sekisui Chemical Co., Ltd.) on the photoalignment film side of substrate A. Separately, a drop of a positive liquid crystal material with a Tni of 71° C. was put onto the photoalignment film side of substrate B.

After the two substrates were joined together in a vacuum, the sealant was cured by irradiating it with light including ultraviolet light with wavelengths between 340 and 450 nm. The workpiece was then heated at 130° C. for 40 minutes for thermal curing of the sealant and reorientation of the liquid crystal layer, completing a test cell of Example 4-1 for liquid crystal display devices (liquid crystal cell).

### Comparative Example 4-1

A test cell of Comparative Example 4-1 for liquid crystal display devices (liquid crystal cell) was obtained in the same way as in Example 4-1 except that a negative liquid crystal material with a Tni of 71° C. was used.

Table 4 is a table that presents test results for <Test 4>.

TABLE 4

| | | Response | | VHR | |
|---|---|---|---|---|---|
| | Liquid | performance | | Before | After |
| | crystal | (τr + τd) | | durability | durability |
| | material | (ms) | Contrast | test | test |
| Example 4-1 | Positive | 23.5 | 1400 | 99.5 | 99.1 |
| Comparative | Negative | 34.5 | 1450 | 98.1 | 91.5 |
| Example 4-1 | | | | | |

### Test 5

### Example 5-1

A paint containing a mixture of a first polyamic acid and a second polyamic acid was coated onto one surface of a substrate having an ITO electrode for the ECB mode (hereinafter referred to as substrate C) and of a counter substrate having a common electrode (hereinafter referred to as substrate D).

The first polyamic acid was the polyamic acid represented by formula (501) below.

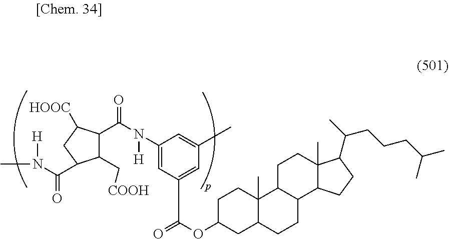

(In the formula, p represents an integer)

The second polyamic acid was a polyamic acid having the repeat unit represented by formula (502) below and the repeat unit represented by formula (503) below. The repeat unit represented by formula (502) below is a “repeat unit having an alkoxysilyl group,” and the repeat unit represented by formula (503) below is a “repeat unit having no alkoxysilyl group.”

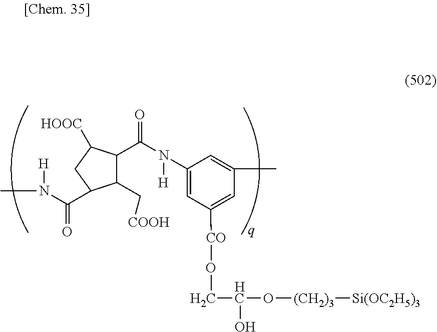

(In the formula, q represents an integer)

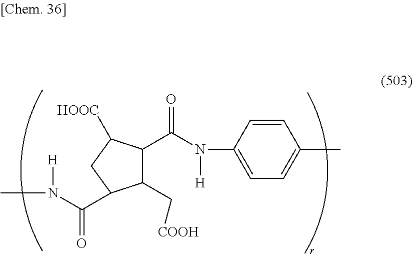

(In the formula, r represents an integer)

The percentage of the first polyamic acid to the total of the first and second polyamic acids was 20% by mass. The percentage of the second polyamic acid was 80% by mass.

In the second polyamic acid, the percentage of the repeat unit represented by formula (502) above to the total of the repeat units represented by formulae (502) and (503) above was 2 mol %.

The coatings were then fired at 80° C. for 2 minutes, then rubbed, and then fired at 200° C. for 40 minutes to complete vertical alignment films. The pretilt angle of the resulting vertical alignment films was 88.5°.

Then a pattern was drawn with a sealant (ultraviolet curable+thermosetting sealant; product name, Photolec; Sekisui Chemical Co., Ltd.) on the photoalignment film side of substrate C. Separately, a drop of a negative liquid crystal material with a Tni of 95° C. was put onto the photoalignment film side of substrate D.

After the two substrates were joined together in a vacuum, the sealant was cured by irradiating it with light including ultraviolet light with wavelengths between 340 and 450 nm. The workpiece was then heated at 110° C. for 40 minutes for thermal curing of the sealant and reorientation of the liquid crystal layer, completing a test cell of Example 4-1 for liquid crystal display devices (liquid crystal cell).

### Example 5-2

A test cell of Example 5-2 for liquid crystal display devices (liquid crystal cell) was obtained in the same way as in Example 5-1 except that the percentage of the repeat unit represented by formula (502) above to the total of the repeat units represented by formulae (502) and (503) above in the second polyamic acid was changed to 10 mol %.

### Example 5-3

A test cell of Example 5-3 for liquid crystal display devices (liquid crystal cell) was obtained in the same way as in Example 5-1 except that the percentage of the repeat unit represented by formula (502) above to the total of the repeat units represented by formulae (502) and (503) above in the second polyamic acid was changed to 30 mol %.

### Example 5-4

A test cell of Example 5-4 for liquid crystal display devices (liquid crystal cell) was obtained in the same way as in Example 5-1 except that the percentage of the repeat unit represented by formula (502) above to the total of the repeat units represented by formulae (502) and (503) above in the second polyamic acid was changed to 40 mol %.

### Comparative Example 5-1

A test cell of Comparative Example 5-1 for liquid crystal display devices (liquid crystal cell) was obtained in the same way as in Example 5-1 except that the percentage of the repeat unit represented by formula (502) above to the total of the repeat units represented by formulae (502) and (503) above in the second polyamic acid was changed to 0 mol %.

Table 5 is a table that presents test results for <Test 5>.

TABLE 5

| | Percentage | Response | | VHR | |
|---|---|---|---|---|---|
| | of formula | performance | | Before | After |
| | (502) | (τr + τd) | | durability | durability |
| | (mol %) | (ms) | Contrast | test | test |
| Example 5-1 | 2 | 28 | 4700 | 99.1 | 98.5 |
| Example 5-2 | 10 | 28 | 5100 | 99.0 | 98.5 |
| Example 5-3 | 30 | 28 | 5100 | 99.0 | 98.0 |
| Example 5-4 | 40 | 28 | 4700 | 98.6 | 96.7 |
| Comparative | 0 | 28 | 4200 | 99.1 | 98.4 |
| Example 5-1 | | | | | |

The test revealed that introducing such an alkoxysilyl-containing repeat unit A as represented by formula (502) above increases contrast.

Example 5-4, moreover, in which the percentage of the repeat unit represented by formula (502) above was 40 mol %, was found to improve contrast but cause a slight decrease in durability.

It is therefore preferred that the amount of introduced repeat unit represented by formula (502) above be less than 40 mol %.

These results indicate that the Examples of the present invention are beneficial.

### INDUSTRIAL APPLICABILITY

Aspects of the present invention can be applied to, for example, a composition that needs to give liquid crystal display devices high performance, a liquid crystal display device that includes this composition, and an electronic apparatus that includes this liquid crystal display device.

### REFERENCE SIGNS LIST

10 . . . Element substrate (pair of substrates); 12 . . . first alignment film; 13 . . . lower alignment film; 14 . . . upper alignment film; 20 . . . counter substrate (pair of substrates); 22 . . . second alignment film; 23 . . . lower alignment film; 24 . . . upper alignment film; 30 . . . liquid crystal layer; 40 . . . seal section; 100 . . . liquid crystal display device; 240 . . . smartphone (electronic apparatus); 250 . . . flat-panel TV (electronic apparatus); 270 . . . laptop computer (electronic apparatus); 280 . . . mobile electronic device (electronic apparatus)

1. A composition comprising a first polyamic acid and a second polyamic acid, wherein:
the first polyamic acid has at least one of a photoreactive functional group and a vertical alignment group; and
the second polyamic acid has a repeat unit having a pendant alkoxysilyl group.

2. The composition according to claim 1, wherein the repeat unit having an alkoxysilyl group is present in an amount of 0.05% by mass or more and 30% by mass or less of the whole composition.

3. The composition according to claim 1, wherein the repeat unit having an alkoxysilyl group contains at least one group selected from the group consisting of formulae (E-201) to (E-206) below.

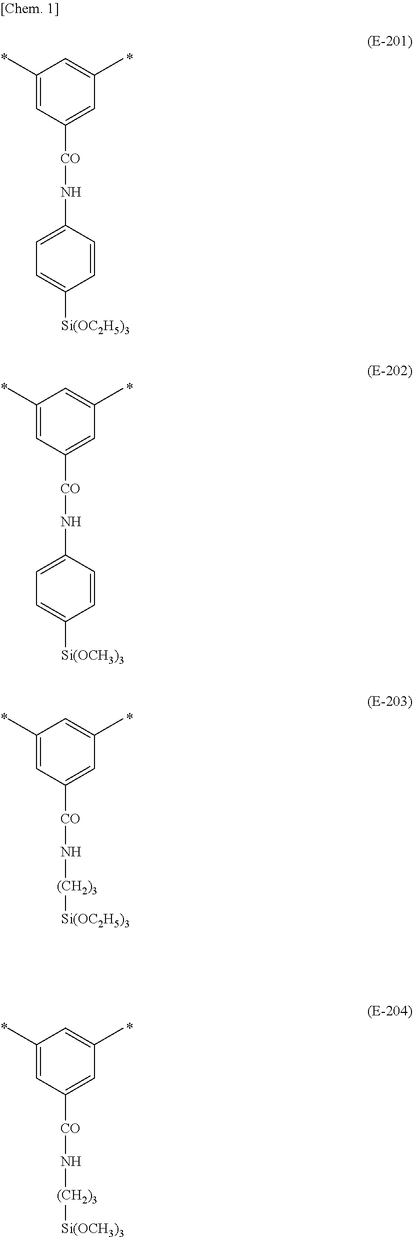

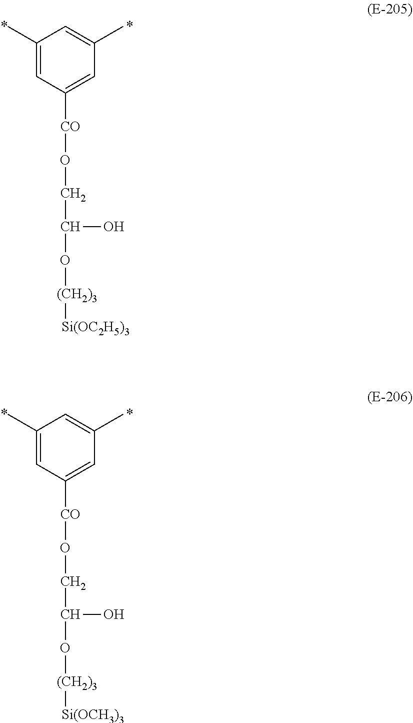

4. The composition according to claim 3, wherein the repeat unit having an alkoxysilyl group is present in an amount of 2 mol % or more and 30 mol % or less of all repeat units forming the second polyamic acid.

5. The composition according to claim 1, wherein the photoreactive functional group is a group having an azobenzene structure or a group having a cyclobutane ring.

6. The composition according to claim 5, wherein the photoreactive functional group is contained in a backbone of the first polyamic acid.

7. A liquid crystal display device comprising:
a pair of substrates;
a liquid crystal layer sandwiched between the pair of substrates; and
alignment films on surfaces of the pair of substrates closer to the liquid crystal layer, wherein:
the liquid crystal layer contains a positive liquid crystal material;
at least one of the alignment films the pair of substrates respectively have is a multilayer film including:
an upper alignment film, which is closer to the liquid crystal layer; and
a lower alignment film, which lies between the upper alignment film and the substrate;
the upper alignment film contains the first polyamic acid;
the lower alignment film contains the second polyamic acid; and
the multilayer film is made from a composition according to claim 1.

8. The liquid crystal display device according to claim 7, wherein the liquid crystal material in the liquid crystal layer contains a liquid crystal compound having an alkenyl group.

9. The liquid crystal display device according to claim 8, wherein the liquid crystal composition contains at least one compound selected from the group consisting of formulae (C-1) to (C-4) below. 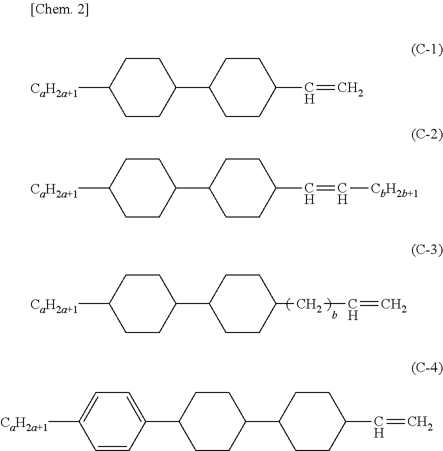
(In the formulae, a and b are mutually independent integers of 1 to 6.)

10. An electronic apparatus comprising a liquid crystal display device according to claim 7.
